(19) United States
(12) Patent Application Publication
(10) Pub. No.: US 2023/0144133 A1
(43) Pub. Date: May 11, 2023

(54) MOUNTING ASSEMBLY FOR FIXING A COMPONENT OF A VEHICLE BRAKE SYSTEM TO A VEHICLE STRUCTURE AND VEHICLE

(71) Applicant: Volvo Car Corporation, Göteborg (SE)

(72) Inventors: Marcel Kapocs, Göteborg (SE); Vaibhav Raut, Göteborg (SE); Thomas Johansson, Göteborg (SE)

(21) Appl. No.: 17/965,856

(22) Filed: Oct. 14, 2022

(30) Foreign Application Priority Data
Nov. 9, 2021 (EP) 21207128.6

(51) Int. Cl. B60T 7/06

(52) U.S. Cl. CPC B60T 7/06

(57) ABSTRACT

A mounting assembly for fixing a component of a vehicle brake system to a vehicle structure. The mounting assembly includes a mounting portion of the vehicle structure having a through hole, a mounting element of the vehicle brake system having a through hole, and a bolt extending through both through holes. Furthermore, a nut engages the bolt such that the mounting portion is attached to the mounting element via the bolt and the nut. Additionally, an elastic bushing is provided having a first bushing collar which extends from a bushing body in a radial direction. The first bushing collar further extends on a first axial side of the corresponding mounting portion or mounting element. Furthermore, a vehicle is presented which includes such a mounting assembly and a vehicle brake system. A component of the vehicle brake system is fixed to a structure of the vehicle via the mounting assembly.

### CROSS-REFERENCE TO RELATED APPLICATION

The present disclosure claims the benefit of priority of co-pending European Patent Application No. 21 207 128.6, filed on Nov. 9, 2021, and entitled “MOUNTING ASSEMBLY FOR FIXING A COMPONENT OF A VEHICLE BRAKE SYSTEM TO A VEHICLE STRUCTURE AND VEHICLE,” the contents of which are incorporated in full by reference herein.

### TECHNICAL FIELD

The present disclosure relates to a mounting assembly for fixing a component of a vehicle brake system to a vehicle structure.

Moreover, the present disclosure is directed to a vehicle having such a mounting assembly and a vehicle brake system.

### BACKGROUND

It is known that components of vehicle brake systems generate noise and vibration when being operated. This is especially the case for brake boosters.

For this reason, usually absorber means are provided in the surroundings of components of vehicle brake systems and especially in the surroundings of brake boosters. These absorber means serve the purpose of attenuating the noise and vibration such that the comfort of the passengers inside the vehicle is not disturbed. In other words, the passenger compartment is isolated from the components of the vehicle brake systems as far as noise and vibrations are concerned.

However, the absorber means are costly both in terms of material costs and in terms of labor cost since they need to be installed in the vehicle.

### BRIEF SUMMARY

An objective of the present disclosure is therefore to provide a solution for attenuating noise and vibrations being generated during the operation of a component of a vehicle brake system, the solution being cost-efficient while maintaining a high level of effectiveness.

The problem is at least partially solved or alleviated by the subject matter of the present disclosure.

According to a first aspect, there is provided a mounting assembly for fixing a component of a vehicle brake system to a vehicle structure, the mounting assembly includes a mounting portion of the vehicle structure having a through hole and a mounting element of the vehicle brake system having a through hole. A bolt extends through the through hole of the mounting portion and through the through hole of the mounting element. The bolt has a bolt head on a first end thereof. Moreover, a nut engages the bolt at a second end portion thereof which is opposed to the first end, wherein the mounting portion is attached to the mounting element via the bolt and the nut. Additionally, an elastic bushing is provided having a bushing body which is arranged in the through hole of the mounting portion or in the through hole of the mounting element. The elastic bushing further has a first bushing collar extending from the bushing body in a radial direction. The first bushing collar extends on a first axial side of the corresponding mounting portion or mounting element. In the present context, the corresponding mounting portion or mounting element is the mounting portion or mounting element having the through hole in which the bushing body of the elastic bushing is arranged. The first axial side is defined with respect to a middle axis of the through hole in which the bushing body is arranged. The first bushing collar may for example be interposed between the mounting portion and the mounting element. Since the bushing is elastic, it provides attenuation or dampening as far as noise and vibration are concerned. This is especially the case for the first bushing collar. If it is interposed between the mounting portion and the mounting element, noise and vibration are hindered from being transferred between these elements. Moreover, the bushing can be sourced on the market at comparatively low cost. This is especially the case when considering the usual mass production in the automotive industry. Additionally, the bushing is easy to install during the mounting of the components of the vehicle brake system. Consequently, the mounting assembly according to the present disclosure offers a cost-efficient solution for dampening noise and/or vibrations.

The elastic bushing can have a second bushing collar extending from the bushing body in a radial direction, the second bushing collar being arranged at an end of the bushing body being opposed to the end at which the first bushing collar is provided. In other words, the bushing has a bushing collar at both of its ends. This means that if the bushing is provided in the through hole of the mounting portion, an elastic bushing collar is provided at both sides of the mounting portion. If the bushing is provided in the through hole of the mounting element, an elastic bushing collar is provided at both sides thereof. In both cases this leads to an effective attenuation of noise and vibration being generated by the operation of the component of the vehicle brake system.

The second collar may be interposed between the nut and the mounting portion or the mounting element along an axial direction of the elastic bushing. As a consequence of this configuration, noise and or vibration can only be transferred to the nut and the bolt cooperating therewith in a dampened manner. This further hinders noise and vibration from reaching a passenger compartment.

It is possible that the bolt extends through the elastic bushing. Put otherwise, the bushing circumferentially surrounds the bolt. This especially applies to the bushing body. This configuration is very compact. Thus, the mounting assembly is suitable for being installed in restraint spaces of the vehicle.

The elastic bushing may be an integral structure. In other words, the elastic bushing may be designed as one piece. This renders the bushing design simple. Moreover, such a bushing can be installed easily within the mounting assembly,

Additionally, the mounting assembly may include a rigid bushing having a bushing body extending through the same through hole as the elastic bushing. The rigid bushing has a radially protruding bushing collar being arranged at an axial end of the bushing body. The bushing collar of the rigid bushing is arranged outside the elastic bushing. Such a rigid bushing can be used for compressing the elastic bushing in a defined and at least locally substantially uniform manner. This way, an attenuation characteristic of the elastic bushing can be set. Moreover, through the rigid bushing, vibrations can be fed into the elastic bushing in order to be attenuated.

The bolt may also extend through the rigid bushing. Again, such a configuration is very compact. Furthermore, the bolt can be used to compress the elastic bushing via the rigid bushing in a defined manner.

The collar of the rigid bushing may be interposed between the nut and the elastic bushing. Consequently, the rigid bushing occupies a very restraint space only.

An end of the rigid bushing being opposed to the collar of the rigid bushing may abut against the mounting portion or the mounting element. Consequently, the rigid bushing can be easily arranged in a defined position. Thus, the mounting portion or the mounting element against which the bushing abuts serves for positioning the rigid bushing. Of course, the rigid bushing being arranged in a defined position can serve for positioning further elements of the mounting assembly.

The mounting assembly may additionally include a stopper member having a through hole through which the bolt extends. The stopper member abuts against the nut and has at least one abutment leg being configured for abutting against the mounting portion or the mounting element. Thus, the stopper member is secured within the mounting assembly by the bolt and the nut. The abutment leg can be used for limiting a relative movement of the parts of the mounting assembly with respect to each other.

In a neutral state of the mounting assembly, a clearance may be provided between an end of the abutment leg and the mounting portion or the mounting element. In this context, a neutral state of the mounting assembly is to be understood as a state, in which neither noise nor vibration results from the component of the vehicle brake system. This means that the elastic bushing is not deformed beyond the deformation resulting from its mounting within the mounting assembly. The clearance, thus, defines a range of movement within the mounting assembly being available for further elastic deformation of the elastic bushing. More precisely, the clearance defines a range of relative movement between the mounting portion and the mounting element.

Moreover, a dampening material may be arranged in an abutment area of the mounting portion or the mounting element, the abutment area being configured for contacting the abutment leg. Thus, in a case in which the abutment leg contacts the abutment area, particularly no noise and/or vibrations are generated. This further enhances the comfort of the vehicle's passengers.

In a variant, the stopper member may be formed as a portion of the rigid bushing. In other words, the stopper member and the rigid bushing are realized as a single part. This leads to a very simple design of the mounting assembly. Moreover, the assembly of the mounting assembly is facilitated since only one part, i.e. the part being both the stopper member and the rigid bushing, needs to be mounted instead of two parts, i.e, the stopper member and the rigid bushing.

On the mounting portion and/or on the mounting element an extension space may be provided radially adjacent to the first bushing collar and/or the second bushing collar of the elastic bushing such that the first bushing collar and/or the second bushing collar can extend into the extension space when being deformed. Consequently, the elastic bushing can freely deform into the extension space. In other words, the deformation of the elastic bushing is not hindered by geometric restraints. Vibration and noise can thus be attenuated in a reliable manner.

According to a second aspect, there is provided a vehicle including a mounting assembly according to the present disclosure and a vehicle brake system. A component of the vehicle brake system is fixed to a structure of the vehicle via the mounting assembly. Consequently, noise and vibration resulting from the operation of the component of the vehicle brake system is effectively attenuated in a cost-effective manner.

In an example, the component of the vehicle brake system is a brake booster.

It should be noted that the above examples may be combined with each other irrespective of the aspect involved.

These and other aspects of the present disclosure will become apparent from and elucidated with reference to the examples described hereinafter.

### BRIEF DESCRIPTION OF THE DRAWINGS

Examples of the disclosure will be described in the following with reference to the following drawings:

FIG. 1 shows a vehicle according to the present disclosure including a mounting assembly according to a first example of the present disclosure,

FIG. 2 shows a sub-assembly of the vehicle of FIG. 1 including the mounting assembly in a perspective view,

FIG. 3 shows the mounting assembly along a direction indicated by arrow III in FIG. 2, wherein remaining components of the sub-assembly of FIG. 2 are not shown,

FIG. 4 shows a sectional view along plane IV-IV in FIG. 3,

FIG. 5 shows a view corresponding to the view of FIG. 3 including a mounting assembly according to a second example of the present disclosure, and

FIG. 6 shows a sectional view along plane VI-VI in FIG. 5.

The figures are merely schematic representations and serve only to illustrate examples of the disclosure. Identical or equivalent elements are in principle provided with the same reference signs.

### DETAILED DESCRIPTION

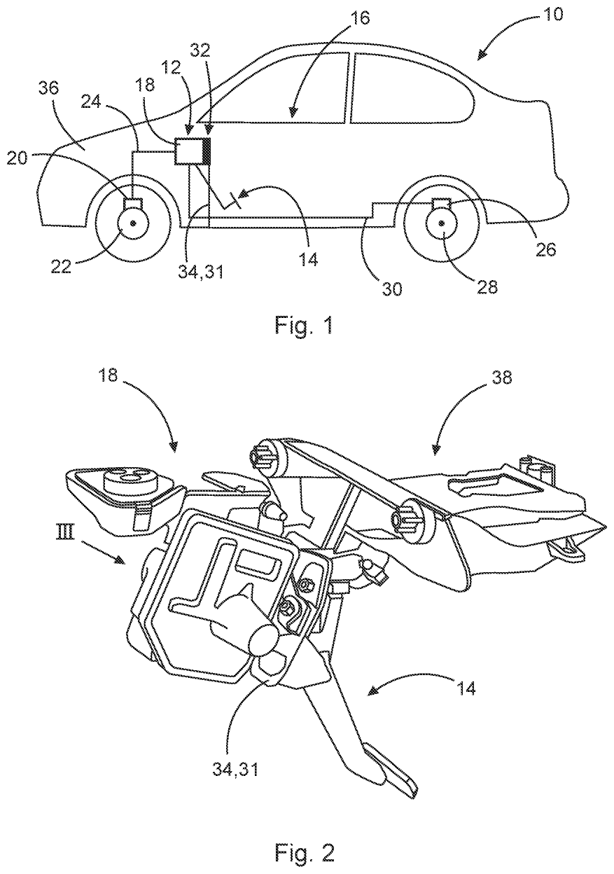

FIG. 1 shows a vehicle 10 having a vehicle brake system 12 being represented in a schematical manner.

The vehicle brake system 12 includes a pedal unit 14 reaching into a passenger compartment 16 of the vehicle 10.

Furthermore, the vehicle brake system 12 has a component 18 being a brake booster which is operationally connected to the pedal unit 14.

For the ease of explanation, the component of the vehicle brake system and the brake booster will both be designated with reference sign 18.

Moreover, an exemplary front brake caliper 20 being adapted for interacting with a front brake disc 22 is connected to the brake booster 18 via an exemplary first brake line 24.

An exemplary rear brake caliper 26 is adapted for interacting with a rear brake disc 28. The rear brake caliper 26 is connected to the brake booster 18 by an exemplary second brake line 30.

The brake booster 18 is fixed to the structure 31 of the vehicle 10 by a mounting assembly 32. More precisely, the brake booster 18 is fixed to a separation wall 34 separating a motor compartment 36 from the passenger compartment 16. Sometimes such a separation wall 34 is designated a firewall. The separation wall 34 obviously forms part of the structure 31 the vehicle 10.

In FIG. 2 the brake booster 18 and the pedal unit 14 are shown in more detail. Also the separation wall 34 is visible. Additionally, a dash panel carrier 38 is represented which is also affixed to the separation wall 34.

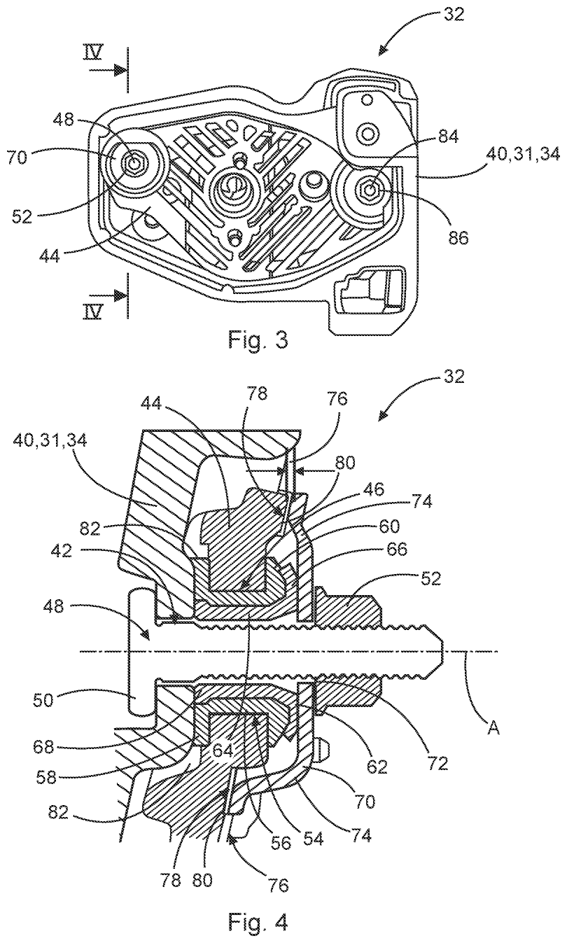

A first example of the mounting assembly 32 will now be explained with reference to FIGS. 3 and 4. In these figures the brake booster 18 is not represented in order to enhance the visibility of the parts of the mounting assembly 32.

The mounting assembly 32 includes a mounting portion 40 of the vehicle structure 31. In the present example the mounting portion 40 is a plate-shaped portion of the separation wall 34.

The mounting portion 40 has a through hole 42 (cf. FIG. 4).

Furthermore, the mounting assembly 32 includes a mounting element 44 of the vehicle brake system 12. In the present example, the mounting element 44 is a substantially plate-shaped mounting element 44 of the brake booster 18.

Also the mounting element 44 has a through hole 46.

Moreover, a bolt 48 is provided which extends through both through holes 42, 46.

The bolt 48 has a bolt head 50 at a first end thereof.

In the present example, the bolt head 50 abuts against the mounting portion 40 on a side being opposite the mounting element 44.

At a second end portion of the bolt 48, which is arranged opposite the first end, and nut 52 is screwed on the bolt 48. This means that an external thread of the bolt 48 engages an internal thread of the nut 50.

Furthermore, and elastic bushing 54 is provided.

The elastic bushing 54 has a bushing body 56 which extends through the through hole 46 of the mounting element 44.

More precisely, the bushing body 56 radially lies against the cylindrical surface forming the circumference of the through hole 46.

The elastic bushing 54 has a first bushing collar 58 extending from the bushing body 56 in a radial direction.

The first bushing collar 58 lies against a rim of the through hole 46. Moreover, the first bushing collar 58 is interposed between the mounting portion 40 and the mounting element 44.

The elastic bushing 54 also has a second bushing collar 60 extending from the bushing body 56 in a radial direction.

The second bushing collar 60 is located at an opposite end of the bushing body 56 as compared to the first bushing collar 58.

The second bushing collar 60 also lies against a rim of the through hole 46. However, the rim against which the second bushing collar 60 lies is arranged on an opposite side as compared to the rim against which the first bushing collar 58 lies.

Beyond that, the second bushing collar 60 is interposed between the nut 52 and the mounting element 44 along an axial direction A of the elastic bushing 54 corresponding to an axial direction of the through holes 42, 46.

The elastic bushing 54, i.e. the bushing body 56, the first bushing collar 58 and the second bushing collar 60, are formed in one piece.

The mounting assembly 32 further includes a rigid bushing 62.

Also the rigid bushing 62 has a bushing body 64.

The bushing body 64 extends through the through hole 46 of the mounting element 44 radially inside the elastic bushing 54.

Moreover, the rigid bushing 62 has a radially protruding bushing collar 66 being arranged at an end of the bushing body 64.

The bushing collar 66 of the rigid bushing 62 is arranged axially outside the second bushing collar 60 of the elastic bushing 54.

The bushing collar 66 axially lies against the second bushing collar 60.

Consequently, the bushing collar 66 of the rigid bushing 62 is interposed between the nut 52 and the elastic bushing 54, more precisely its second bushing collar 60.

Moreover, the rigid bushing 62 is arranged within the mounting assembly 32, such that an end 68 thereof being arranged opposite the bushing collar 66 abuts against the mounting portion 40.

The bolt 48 extends through the center of the rigid bushing 62.

Since the rigid bushing 62 is arranged at least partially radially inside the elastic bushing 54, the bolt 48 also extends through the elastic bushing 54.

The mounting assembly 32 additionally includes a stopper member 70 being generally shaped in the form of half-shell and having a through hole 72 through which the bolt 48 extends.

On a first side, the stopper member 70 abuts against the nut 52.

On a second, opposing side, the stopper member 70 abuts against the bushing collar 66 of the rigid bushing 62.

Thus, a central portion of the stopper member 70 is interposed between the nut 52 and the rigid bushing 62.

The stopper member also has an abutment leg 74 which is configured for abutting against the mounting element 44.

In the present example, the abutment leg has a substantially circular shape when considering a middle axis A of the through hole 72 as a center. However, the axial length of the abutment leg 74 differs from its circumference.

In order to provide a defined range of motion of the mounting element 44, a clearance 76 is provided between an end of the abutment leg 74 and an abutment area 78 of the mounting element 44. This, of course, is only the case in a neutral state of the mounting assembly 32 which is shown in FIGS. 3 and 4.

In order to render a potential contact between the abutment leg 74 and the mounting element 44 soft, a dampening material 80 is arranged on the abutment area 78.

The mounting portion 40 is, thus, attached to the mounting element 44 by means of the bolt 48, the elastic bushing 54, the rigid bushing 62, the stopper member 70 and the nut 52.

Thereby, the rigid bushing 62 and the stopper member 70 are rigidly fixed to the mounting portion 40 by the bolt 48 and the nut 52. This is due to the fact that the end 68 of the rigid bushing 62 rigidly abuts against the mounting portion 40 and the stopper member 70 is held rigidly against the rigid bushing 62 by the nut 52.

Moreover, the elastic bushing 54 is compressed in a defined manner if the rigid bushing 62 is mounted on the mounting portion 40 such that the end 68 of the rigid bushing abuts against the mounting portion 40. A dimension of an axial space being available for the elastic bushing 54 in the mounted condition, thus, corresponds to a distance between the end 68 of the rigid bushing 62 and its bushing collar 66.

However, the mounting element 44 is able to move in a first axial direction with respect to the mounting portion 40 by compressing the first bushing collar 58.

Additionally, the mounting element 44 can move in a second axial direction with respect to the mounting portion 40 by physically compressing the second bushing cover 60. However, the range of movement in the second axial direction is limited by the size of the clearance 76. Once the clearance 76 is overcome, the mounting element 44 abuts against the stopper member 70

Moreover, the mounting element 44 is able to move in a radial direction by deforming the bushing body 56.

In order not to geometrically limit the elastic deformation of the elastic bushing 54, an extension space 82 is provided radially adjacent to the first bushing collar 58 such that the latter can extend into the extension space 82 when being deformed.

In the present example, the extension space 82 is a geometrical feature of the mounting element 44.

During operation of the brake booster 18, such movements of the mounting element 44 will be generated as parts of vibrations. Due to the above-explained deformation of the elastic bushing 54, these vibrations are not transferred to the mounting portion 40 or are at least attenuated before being transferred to the mounting portion 40.

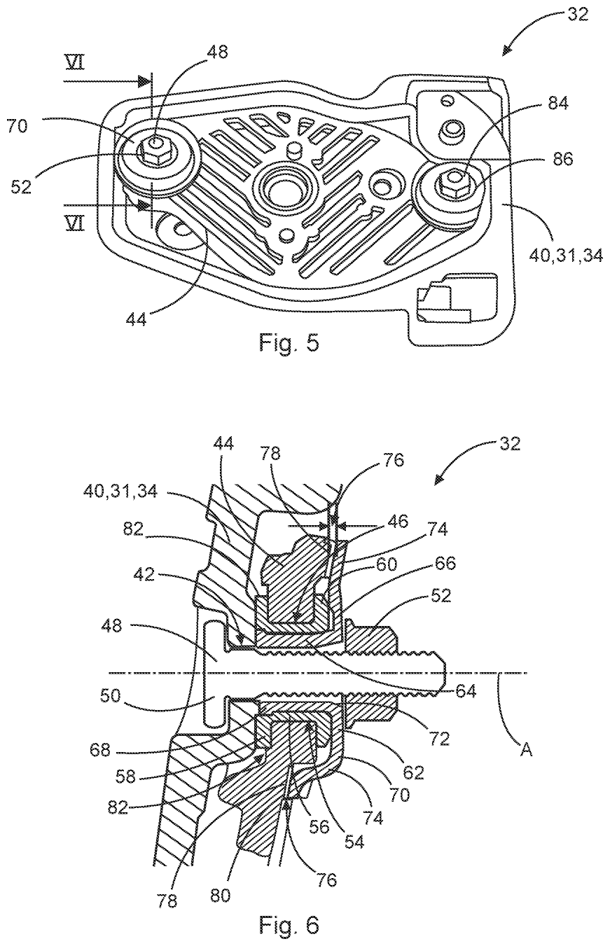

A second example of the mounting assembly 32 will now be explained with reference to FIGS. 5 and 6. Again, in these figures the brake booster 18 is not represented in order to enhance the visibility of the parts of the mounting assembly 32.

The mounting assembly 32 according to the second example only differs from the mounting assembly 32 of the first example in that the stopper member 70 is formed as a portion of the rigid bushing 62. In other words, the stopper member 70 and the rigid bushing 62 are formed as one part.

In the second example, one can imagine the stopper member 70 and its abutment leg 74 being formed by prolonging the bushing collar 66 of the rigid bushing 62.

Beyond that, reference is made to the explanations given in respect of the first example.

It is noted that in the first example and the second example, the mounting element 44 is not only mounted on the mounting portion 40 via the bolt 48 and the nut 52 as has been explained before. In both examples a second bolt 84 and a second nut 86 are provided.

However, in both examples, the fixation of the mounting element 44 on the mounting portion 40 via the second bolt 84 and the second nut 86 is realized in the same manner as the fixation via the bolt 48 and the nut 52. Thus, reference can be made to the above explanations.

In other words, the representations shown in FIGS. 4 and 6 also show the fixation via the respective second bolt 84 and the respective second nut 86.

It is additionally understood that the mounting assembly 32 as explained above could be kinematically inverted without departing from the general idea underlying the present disclosure. This means that the elastic bushing 54 and the rigid bushing 62 could as well be arranged in the through hole 42 of the mounting portion 40 and the bolt head 50 could abut against the mounting element 44.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. Any reference signs in the claims should not be construed as limiting the scope of the claims.

1. A mounting assembly for fixing a component of a vehicle brake system to a vehicle structure, the mounting assembly comprising:
a mounting portion of the vehicle structure having a through hole,
a mounting element of the vehicle brake system having a through hole,
a bolt extending through the through hole of the mounting portion and the through hole of the mounting element, the bolt having a bolt head on a first end thereof,
a nut engaging the bolt at a second end portion thereof which is opposed to the first end,
wherein the mounting portion is attached to the mounting element via the bolt and the nut,
an elastic bushing having a bushing body which is arranged in the through hole of the mounting portion or in the through hole of the mounting element, and
a first bushing collar extending from the bushing body in a radial direction, the first bushing collar extending on a first axial side of the corresponding mounting portion or mounting element,

2. The mounting assembly according to claim 1, wherein the elastic bushing has a second bushing collar extending from the bushing body in a radial direction, the second bushing collar being arranged at an end of the bushing body being opposed to the end at which the first bushing collar is provided.

3. The mounting assembly according to claim 2, wherein the second bushing collar is interposed between the nut and the mounting portion or the mounting element along an axial direction of the elastic bushing.

4. The mounting assembly according to claim 1, wherein the bolt extends through the elastic bushing. 5, The mounting assembly according to claim 1, wherein the elastic bushing is an integral structure.

6. The mounting assembly according to claim 1, further comprising a rigid bushing having a bushing body extending through the same through hole as the elastic bushing and a radially protruding bushing collar being arranged at an axial end of the bushing body, the bushing collar of the rigid bushing being arranged outside the elastic bushing.

7. The mounting assembly according to claim 6, wherein the bolt extends through the rigid bushing.

8. The mounting assembly according to claim 6, wherein the collar of the rigid bushing is interposed between the nut and the elastic bushing.

9. The mounting assembly according to claim 6, wherein an end of the rigid bushing being opposed to the collar of the rigid bushing abuts against the mounting portion or the mounting element.

10. The mounting assembly according to claim 1, further comprising a stopper member having a through hole through which the bolt extends, the stopper member abutting against the nut and having at least one abutment leg being configured for abutting against the mounting portion or the mounting element.

11. The mounting assembly according to claim 10, wherein in a neutral state of the mounting assembly, a clearance is provided between an end of the abutment leg and the mounting portion or the mounting element.

12. The mounting assembly according to claim 10, wherein a dampening material is arranged in an abutment area of the mounting portion or the mounting element, the abutment area being configured for contacting the abutment leg.

13. The mounting assembly according to claim 10, wherein the stopper member is formed as a portion of a rigid bushing having a bushing body extending through the same through hole as the elastic bushing.

14. The mounting assembly according to claim 2, wherein on the mounting portion and/or on the mounting element an extension space is provided radially adjacent to the first bushing collar and/or the second bushing collar of the elastic bushing such that the first bushing collar and/or the second bushing collar can extend into the extension space when being deformed.

15. A vehicle comprising the mounting assembly according to claim 1 and the vehicle brake system, wherein a component of the vehicle brake system is fixed to the structure of the vehicle via the mounting assembly.
